(19) United States
(12) Patent Application Publication
(10) Pub. No.: US 2019/0032693 A1
(43) Pub. Date: Jan. 31, 2019

(54) Expansion Anchor Setting Tool

(71) Applicant: HammerDragon, LLC, Bryan, TX (US)

(72) Inventors: Justin G. Holub, Bryan, TX (US); Ross C. Morel, Bryan, TX (US)

(73) Assignee: HammerDragon, LLC, Bryan, TX (US)

(21) Appl. No.: 15/659,297

(22) Filed: Jul. 25, 2017

(51) Int. Cl. F16B 13/06; E04B 1/41; E21B 10/20

(52) U.S. Cl. CPC F16B 13/066; E04B 1/4121; B25D 17/088; E04B 1/4157; E21B 10/20

(57) ABSTRACT

A method and device for setting expansion anchors that includes an elongate rod having a proximal end, a center section, and a distal end. The proximal end and the center section can have an effective diameter of a given expansion anchor. The distal end can have a reduced effective diameter to fit inside the open center space of the given expansion anchor.

### FIELD OF THE INVENTION

This invention relates to tools for setting expansion anchors. Specifically, it relates to tools for use in a hammer drill to set expansion anchors more effectively and safely than the hand tools currently used.

BACKGROUND

During the construction process, various setting devices are used to install anchors into rigid materials, i.e., concrete, masonry, stone and like materials. During installation of the anchor, an appropriately sized hole is drilled to an appropriate depth into the rigid material, usually with a hammer drill, the hole cleaned, the drill set aside, the anchor placed on the end of a hand setting tool and the anchor set in place by striking the tool with a hammer. This is an awkward, tiring and often unsafe practice, especially when the anchors are being set overhead, the ladder or other support is unstable and the worker is tired. Therefore, a need exists for a setting device that is capable of eliminating the need to switch from one tool to another during the anchor setting process.

The nature and use of drop in anchors as well as the desirability of having a better means of setting them is well described in U.S. Pat. No. 8,974,163B2 and U.S. Pat. No. 7,814,631B2, the Background sections of each being incorporated herein by reference. SUMMARY

Attachment to concrete and the like is most often accomplished with special expansion anchors called “Drop In” anchors. These so called “Drop In” anchors are devices used to attach items to solid surfaces such as concrete, masonry, stone and like materials. Anchors are cylindrical devices essentially wedged into holes in the concrete and which usually have internal female bolt threads into which bolts are placed for attachment of hangers and the like. These internally-threaded, deformation-controlled expansion anchors have a preassembled expander plug, suitable for flush mount applications in solid base materials.

The anchor is “set” by driving the expansion plug located in the annular space of the anchor towards the bottom of the anchor using the setting tool. These anchors generally have cylindrical metal bodies, an internal threaded section at one end, an internal setting plug (expansion plug), and a tapered slit at the opposite end. With the anchor in place in an appropriate drill hole in the rigid material, the tapered (tapered toward the slit end) setting plug is driven forward toward into the slit end causing it to expand and “set” (wedge) the anchor against the sides of the hole to lock it into place. The setting plug is customarily driven into place with a hand tool and hammered in. Since drop in anchors are often placed overhead, as in building beams for attachment of wiring, plumping, ceiling support, and the like, setting the anchor with a hand tool can be awkward and tiresome.

The holes for drop in anchors are customarily drilled with rotary hammer drills. Hammer drills are well suited for drilling holes in masonry or stone. They are also used to drill holes in concrete footings to pin concrete wall forms and to drill holes in concrete floors to pin wall framing. The hammering action helps to break up the masonry so that it can be removed by the drill bit's flutes. A hammer drill, is also known as a rotary hammer, roto-hammer or impact drill, is a rotary drill with a hammering action. The hammering action provides a short, rapid hammer thrust to pulverize relatively brittle material and provide quicker drilling with less effort. Lower power units are usually titled as hammer drills. Higher power units, usually labeled rotary hammers, tend to be larger and provide bigger impact forces. Modern units allow the hammer and rotation functions to be used separately or in combination, i.e., hammer mode, drill mode, or both.

Drop-in anchors come in five sizes, ¼″, ⅜″, ½″, ⅝″, ¾″. The size of the anchor reflects the diameter of the threaded rod or bolt that can be inserted into the anchor, thus the hole to be drilled is larger than anchor size. The anchor size is designated by the inside diameter of the anchor. The diameter of the hole to be drilled is the same size as the outside diameter of the anchor. For example, a ¼″ drop in anchor requires a ⅜″ hole.

The present invention provides a setting device that is driven by the hammer drill, thus eliminating the need to switch from one tool (hammer drill) to a separate hand setting tool. The advantages of the rotary drill adapted setting tool of this invention includes allowing the use of one hand operation (rather than two needed for the hand tool), it sets the anchors deeper, better and faster, e.g., with a three (3) second push of the rotary drill rather than ten swings with a ten (10) pound hammer. This tool allows a more stable manual position for the worker and can thus be used by any applicator on any job site, by younger, older, disabled, or inexperienced workers.

### BRIEF DESCRIPTION OF DRAWINGS

FIG. 1 is a side view of a first embodiment of the setting tool, as shown and described herein.

FIG. 1A is a top-side view of a first configuration of the tool of FIG. 1, as shown and described herein.

FIG. 1B is a top-side view of a second configuration of the tool of FIG. 1, as shown and described herein.

FIG. 1C is a top-side view of a third configuration of the tool of FIG. 1, as shown and described herein.

FIG. 1D is a top-side view of a fourth configuration of the tool of FIG. 1, as shown and described herein.

FIG. 2 is a perspective view of the bottom end of the tool of FIG. 1, as shown and described herein.

FIG. 3 is a bottom-side view of one end of the tool of FIG. 1, as shown and described herein.

FIG. 4 is a side view of a second embodiment of the setting tool, as shown and described herein.

FIG. 4A is a top-side view of the tool of FIG. 4, as shown and described herein.

FIG. 4B is a side view of a first detachable member of the tool of FIG. 4, as shown and described herein.

FIG. 4C is a bottom-side view of the detachable member of the tool of FIG. 4, as shown and described herein.

FIG. 5 is a side view of a second detachable member of the tool of FIG. 4.

FIG. 6 is a side view of a third embodiment of the setting tool, as shown and described herein.

FIG. 6A is a side view of a first rotatable member of the tool of FIG. 6.

FIG. 6B is a side view of a second rotatable member of the tool of FIG. 6.

FIG. 6C is a side view of the rotatable member of the tool of FIG. 6B.

### DETAILED DESCRIPTION

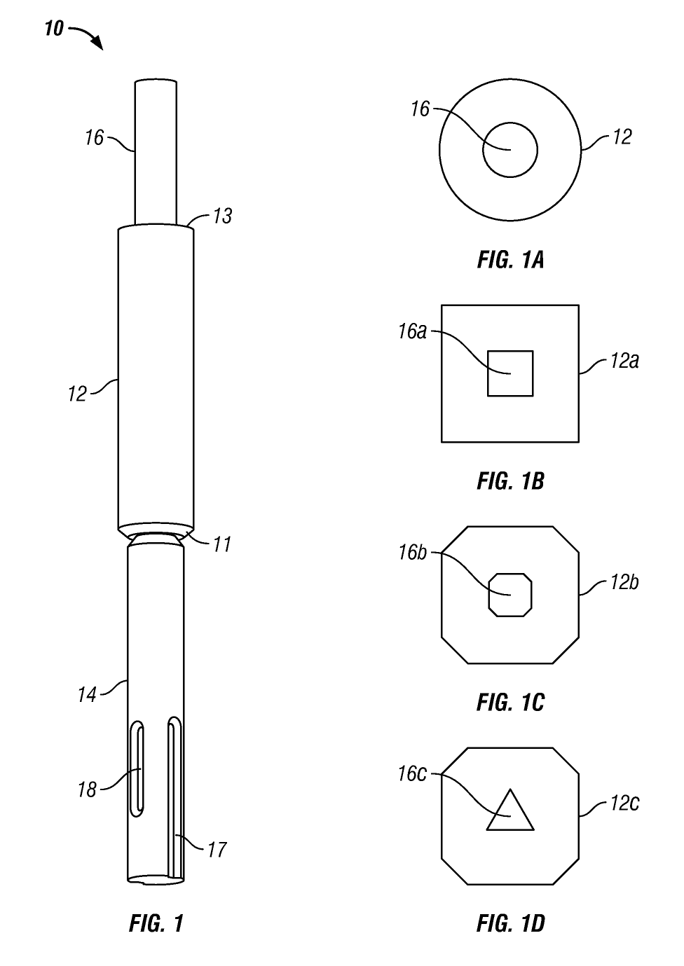

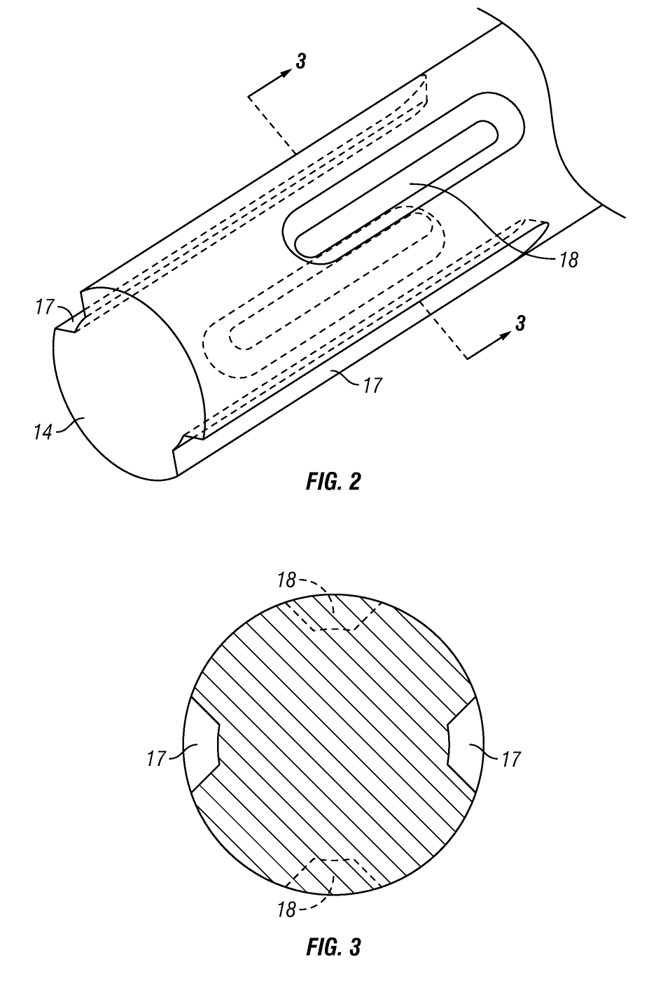

This invention is an expansion anchor setting tool that is attachable to and driven by a hammer drill. It is a device for setting expansion anchors comprising; an elongate rod, having a proximal end, a center section and a distal end. The proximal end and the center section have an effective diameter of a given expansion anchor and the distal end is of reduced effective diameter to fit inside the open center space of the given expansion anchor. The elongate rod comprises three distinct sections: the hammer drill chuck receiving end (proximal end), a center section and the setting tool section (distal end). In one embodiment, these sections are a single rod in which the sections are fashioned to accomplish the required functions. FIG. 1 is a side view of a first embodiment of the setting tool. The setting tool 10 has a proximal end 14 that is shaped and designed to fit the chuck of a hammer drill. It has slots 17 and 18 and taper element 11 necessary for a hammer drill chuck. Referring to FIG. 1, for illustrative purposes, the setting fitted for a nominal ⅜″ drop in anchor has the dimensions: overall length is 127 mm; the element 12 will be 48.5 mm long and 12 mm diameter; element 16 will be 23.5 mm long and 7.5 mm diameter; and the element 11 will be a 45° angle. The diameter of center section 12 will be sized so that the surface 13 will match the face of the anchor bolt so as not to exceed the diameter of the hole drilled to receive the anchor. The center section 12, and distal end 16, may have a variety of cross sectional shapes as discussed below. The tool will be sized to accommodate each size expansion anchor. Generally, the drill chuck end (proximal) will be the same for each size hammer drill. The center section and setting size will change.

FIGS. 2 and 3 show details for a shaft 14, suitable for a standard hammer drill chuck that will fit hammer drills made, for example, by Milwaukee®, DeWalt®, Hitachi®, and Porter Cable®. FIG. 2 is a perspective view showing the location of the special fitting grooves for the drill chuck end. FIG. 3 is an end view showing the slots 17 and 18 for the drill chuck. The center section 12, may be any suitable length and cross-sectional shape. It is shown to be cylindrical in shape, but it may be square, square with rounded edges, hexagonal, triangular or any other shape. FIGS. 1A, 1B, 1C and 1D) are top views of the tool in FIG. 1 and illustrate some of the variations in shape that may be used. FIG. 1A shows the cross sections of 16 and 12 as cylindrical. FIG. 1B shows the body 12a as square and the setting end 16a as square. FIG. 1C shows the body 12b as square with rounded edges and the setting end 16b, also square with rounded edges. FIG. 1D shows the body 12c as hexagonal and the setting end 16c triangular. Any permutation of these shapes and others are suitable. As used herein these cross configurations are termed polygonal configurations. Cylindrical or square with rounded edges are preferred configurations. The center section 12, may be any length and cross-sectional shape, so long as the effective diameter is larger than the diameter of the proximal end 14 and the distal. end 16. “Effective diameter” as used herein is that cross section dimension that will allow a given cross section piece to fit into the threaded opening of an expansion anchor, for example for a circular cross section the effective diameter will be the diameter, for a square piece it will be the distance from side to side, for a triangle it will be the longest side (not diagonal), for a polygon it will be the distance from one side to the opposite side.

The distal, anchor setting end 16, like the drill chuck end, has a constrained configuration. It is configured to mate with the expansion anchor face and opening to which it is to be applied.

The dimensions for varying commercial expansion anchors (from one manufacturer) are shown in Table 1.

TABLE 1
Typical Expandable bolt dimensions in inches.

| Anchor Size | Overall length | Bolt diameter |
|---|---|---|
| ¼″ | 1″ | ¼″ |
| ⅜″ | 1 9/16″ | ⅜″ |
| ¼″ | 2″ | ¼″ |
| ⅝″ | 2½″ | ⅝″ |
| ¾″ | 3 3/18″ | ¾″ |

The dimensions in Table 1 are from one manufacturer, and are not intended to be limiting. Other anchors may be of shorter or longer length and/or other dominions. The setting end 16, will have an effective diameter, or be dimensioned to fit into a bolt hole of the expansion bolts, as for example those in Table 1.

In another embodiment, at least the distal setting end can be magnetized. This will help to releasably connect the anchor to the setting tool. The magnetized end will be effective for those expandable bolts that are iron or steel. Even those of stainless or other nonmagnetic material may have an iron plug that can magnetically link to the magnetized setting end of the tool.

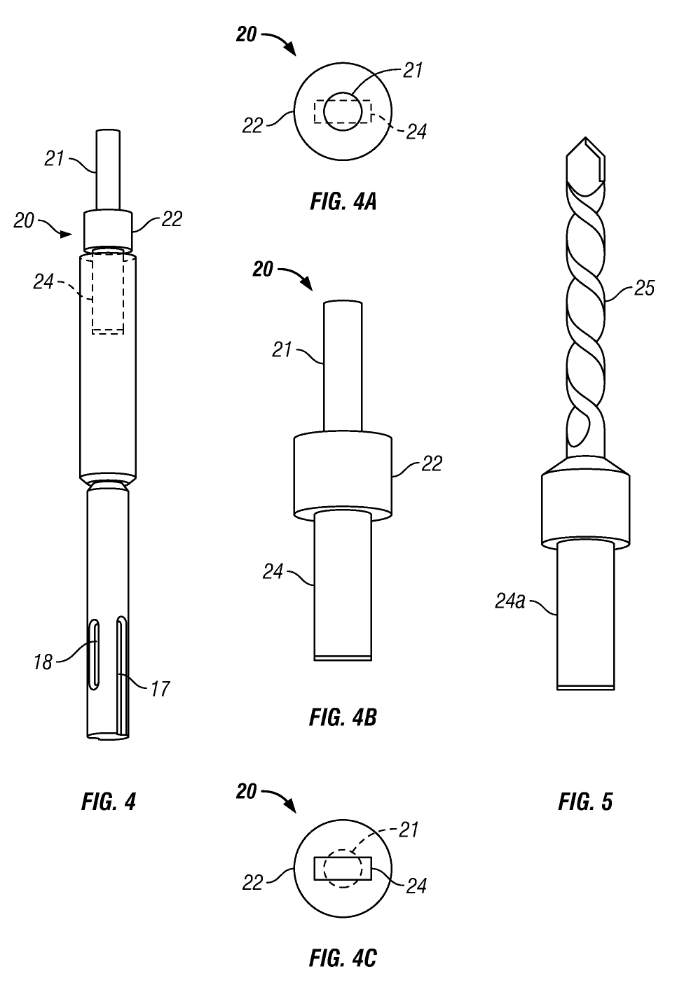

FIG. 4 is a side view of a second embodiment of the setting tool. In this second embodiment, the distal setting end of the tool can be detachable from the body of the elongate rod (center section) as illustrated in FIG. 4. The detachable setting member 20, comprises a setting end 21, a body 22, and an attachment end 24. This detachable member is fitted into a matching hole in the body 13 shown as element 23. FIG. 4A is a top view of this detachable member, 4B a side view and 4C a bottom view. As shown in FIG. 4 the attachment end of the setting member is rectangular, but it may be any suitable shape. However, it must be shaped so as not to rotate when the drill is in operation. Various ways and means to attach the setting member to the body of the tool will be obvious to those skilled in the art. An additional detachable member, shown in FIG. 5, has a drill bit 25 in place of the setting end. Thus, with this embodiment, changing from the drill bit needed for drilling the expandable anchor hole and setting the anchor with the hammer drill only requires changing the detachable member. The setting end and the drill may be any size needed for available anchor bolts. So, there may be a detachable piece 20 sized for each needed expansion anchor with appropriately sized drill bits and setting end. As illustrated in FIGS. 1A-1D the setting end piece may be any suitable shape.

The detachable member may be magnetized to assist in holding the expandable bolt on the tool while it is being placed in the anchor hole. The magnetized end will be effective for those expandable bolts that are iron or steel. Even those of stainless or other nonmagnetic material may have an iron plug that will magnetically link to the magnetized setting end of the tool. The body 12 may also be magnetized with an opposite polarity as the setting member so that there is a stronger bond between the member and body.

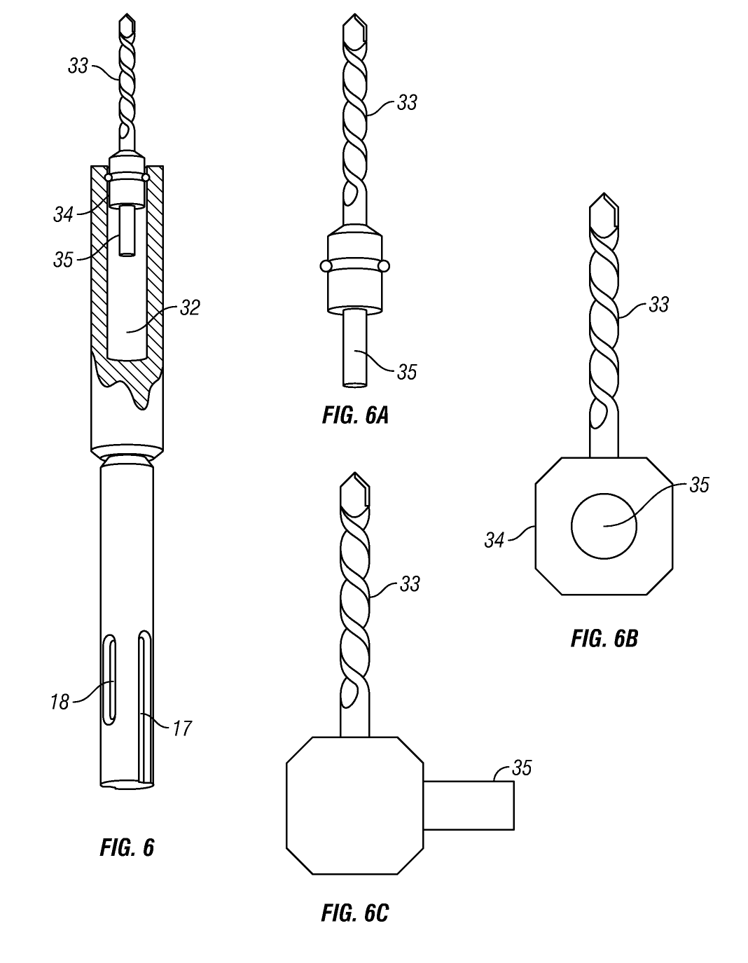

FIG. 6 is a side view of a third embodiment of the setting tool. In this embodiment, a drill/setting member, somewhat like the detachable member described above, is placed in a rotation member such as a fork 32, and built into the body 12, as shown in FIG. 6. In this embodiment, a member 34 is rotatably located in a means for receiving a setting member which allows the setting member to rotate (such as a fork shaped opening) 32 of the body 12. This rotatable member will have a drill bit end 33 and an anchor setting end 35. Other means of providing a means for holding the rotatable drill/setting member will be obvious to those skilled in the art. This setting member, like the detachable member, may be of any suitable shape, and any suitable size but will have a drill at one end 33, and setting end 35, at the other. In operation, it is possible to switch from drill mode to set mode by flipping the member 34 as needed. This can be done by simply pulling the detachable piece, members 33, 34 & 35, out of the fork after drilling the hole and rotate the detachable piece 180° before inserting back into the fork. For example, an operator can drill the hole with member 33 protruding outward (as shown in FIG. 6) and then remove the detachable pieces 33, 34, 35 and rotate 180 degrees, and reinsert into the setting tool so that member 35 is protruding outward. From here, the operator can use the hammer part of the tool and set the anchor,

FIG. 6b and 6c illustrate another variation where the drill bit 33, and setting end 43 are configured in an L shape (at right angles to each other) around a body 42. This embodiment allows the member to be rotated in a much shallower, and therefore stronger, fork than the straight member of FIGS. 6 and 6a. As in the detachable member embodiment of FIG. 4 the member 34 may be magnetized. The magnetized member 34 is effective in holding the expandable anchor and keeping it secure to the tool. In the field, this is an advantage and luxury aspect of the tool. For example, there are times while setting the anchor that the installer may be in an awkward position on a ladder several feet above the ground. The magnetized member 34 prevents the anchor from falling to the floor, thus increasing the operator's efficiency and/or reducing the likelihood of injury to someone standing below.

In general, material useful for drills and punches such as hardened steel will be preferred for cost effectiveness and durability. The term hardened steel is often used for a medium or high carbon steel that has been given the heat treatments of quenching followed by tempering. However other materials are also suitable and may be used especially for special applications as will be obvious to those skilled in the art.

The anchor is “set” by driving the expansion plug located in the annular space of the anchor towards the bottom of the anchor using the setting tool. Since drop in anchors are often placed overhead, as in building beams for attachment of wiring, conduit, plumbing, ductwork, HVAC piping, ceiling support, and the like, setting the anchor with a hand tool can be awkward, tiresome, unsafe and in some cases, does not allow the anchor to be set at all if scissor lift safety precautions are met. The scissor lift is built with a work platform, mid rail and top rail. These guard rails are not to be stood on and are there to ensure that worker does not fall out. However, there are instances when the scissor lift cannot be raised any higher to the bottom of the concrete structure, of which an operator need to comfortably reach to set the anchor using both left and right hands. Instances when the scissor lift height is limited out include situations when systems like plumbing, ductwork, ceiling support, etc., are already hung and supported by hangers. An operator cannot raise the scissor lift through these systems. Also, due to things like housekeeping concrete pads on the ground, an operator may not be able to drive the scissor lift directly under the location of where an operator needs to drill the hole and set the anchor. Both situations happen regularly and puts the worker in a situation where he/she has to reach over the top railing outside of the scissor lift boundary and step on the mid rail of the scissor lift in order to use both hands to set the anchor one hand holding the set tool with anchor and the other holding a sledge hammer. This practice of stepping on the mid/top guard rail is unsafe and considered illegal on a most jobsites.

With the invention disclosed herein, this unsafe job can become a lot safer. Instead of reaching out over the top rail swinging a hammer approximately 10 times for every anchor, the operator will be able to use one hand holding the hammer drill with the invention attached. The other free hand could be utilized for holding onto the top rail for extra support. For balance purposes, it is safer and less awkward to reach furthest with one hand than it is reaching with two. An operator can reach out far with his right hand holding the hammer drill keeping his weight on his right foot while holding onto the top rail with his left hand.

Step by step usage of the tool starts by identifying the size anchor that needs to be set. Once the size anchor is determined then an operator gathers the hammer drill and drill bit/expansion anchor set tool of the necessary size. Once the desired location of the hole/anchor is determined, the operator can then set the hammer drill into “drill” mode and ensure that the appropriate drill bit is inserted into the chuck of the drill for use. The operator can then safely drill the hole to the desired depth, and then replace/switch the drill bit in the chuck of the hammer drill so the set tool portion of the tool can be utilized. At this point it is not necessary to switch the hammer drill to “hammer” mode but can be if preferred. Next, the operator can place the appropriately sized anchor onto the tip (e.g., piece 16 of FIG. 1, piece 21 of FIG. 4, piece 35 of FIG. 6) of the expansion anchor set tool. The operator can now guide the anchor using the hammer drill into the previously drilled hole and activate the hammer drill until the anchor is fully set. The anchor is fully set once the edge of the drop-in anchor meets piece 13 of FIG. 1, piece 22 of FIG. 4 and/or piece 34 of FIG. 6 (usually takes around 5 seconds). By following these steps, the operator has successfully and safely set a drop in anchor and can repeat the process as needed.

While the invention has been particularly shown and described as referenced to the embodiments thereof, those skilled in the art will understand that the foregoing and other changes in form and detail may be made therein without departing from the spirit and scope of the invention.

What is claimed is:

1. A device for setting expansion anchors comprising:
an elongate rod having a proximal end, a center section, and a distal end,
wherein the proximal end and the center section have an effective diameter of a given expansion anchor, and
wherein the distal end is of reduced effective diameter to fit inside the open center space of the given expansion anchor.

2. The device of claim 1, wherein the distal end is of a length of the opening in a given expansion anchor.

3. The device of claim 1, wherein the at least one of the center section or distal end have polygonal cross section shape.

4. The device of claim 1, wherein of the distal end is made of hardened carbon steel.

5. The device of claim 1, wherein at least the distal end is magnetized.

6. A device for setting expansion anchors comprising:
a first elongate rod having a proximal end member shaped to fix a hammer drill chuck and
a distal end member which has an opening in the end away from the proximal end member to receive an anchor setting member, wherein the anchor setting member comprises:
a rear section having a configuration to fit into the opening of the first distal member and.
a distal section having an effective diameter to fit inside the open center space of the given expansion anchor.

7. The device of claim 6 wherein at least one of the center section and distal end section have polygonal cross section shape.

8. The device of claim 6, wherein the anchor setting member is magnetized.

9. A device for setting expansion anchors comprising:
a first elongate rod, having a proximal end member shaped to fix a hammer drill chuck and
a distal end member which has a means for receiving a setting member which allows the setting member to rotate, the setting member comprises:
a rear section drill bit and
a distal section having an effective diameter to fit inside the open center space of the given expansion anchor, said anchor setting member being attached rotably in the receiving means of the first distal end member.

10. The device of claim 9, wherein the anchor setting member is magnetized so that it is held to the first member opening.

11. The device of claim 9, wherein the rear section drill bit and a setting end are configured at right angles to each other.
